(19) United States
(12) Patent Application Publication
(10) Pub. No.: US 2002/0029354 A1
(43) Pub. Date: Mar. 7, 2002

(54) Non-volatile write cache, in a disc drive, using an alternate power source

(75) Inventors: Monty Aaron Forehand, Yukon, OK (US); Kevin Dean Fruendt, Yukon, OK (US); Virat Thantrakul, Oklahoma City, OK (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 09/894,152

(22) Filed: Jun. 27, 2001

Related U.S. Application Data
(60) Provisional application No. 60/227,612, filed on Aug. 23, 2000.

(51) Int. Cl. G06F 1/26; G06F 1/28; G06F 1/30; G06F 11/30

(52) U.S. Cl. 713/340

(57) ABSTRACT

A non-volatile write cache using an alternate power source is implemented in a disc drive to maintain the integrity of cached write commands during a standard disc drive power loss, and to further recover and execute outstanding cached write commands when standard disc drive power is restored. The disc drive includes an internal or external alternate power source, control circuitry to switch between normal and low-power modes, memory control circuitry to, when in low-power mode, maintain the refresh of the cache, and firmware to recover and execute cached write commands once power is restored.

### RELATED APPLICATIONS

This application claims priority of United States provisional application Serial No. 60/227,612, filed Aug. 23, 2000.

### FIELD OF THE INVENTION

This application relates generally to data integrity in a disc drive having logical sectors, and more particularly to a preserving unwritten data in a write cache during a standard power loss via switching to an alternative backup power source so that the data may be written to the media once standard power has been restored.

### BACKGROUND OF THE INVENTION

Disc drives are data storage devices that store digital data in magnetic form on a rotating storage medium called a disc. Modern disc drives comprise one or more rigid discs that are coated with a magnetizable medium and mounted on the hub of a spindle motor for rotation at a constant high speed. Each surface of a disc is divided into several thousand tracks that are tightly-packed concentric circles similar in layout to the annual growth rings of a tree. The tracks are typically numbered starting from zero at the track located outermost the disc and increasing for tracks located closer to the center of the disc. Each track is further broken down into sectors and servo bursts. A sector is normally the smallest individually addressable unit of information stored in a disc drive and typically holds 512 bytes of information plus a few additional bytes for internal drive control and error detection and correction. This organization of data allows for easy access to any part of the discs. A servo burst is a particular magnetic signature on a track which facilitates positioning of heads over tracks.

Generally, each of the multiple discs in a disc drive has associated with it two heads (one adjacent the top surface of the disc, and another adjacent the bottom) for reading and writing data to a sector. A typical disc drive has two or three discs. This usually means there are four or six heads in a disc drive carried by a set of actuator arms. Data is accessed by moving the heads from the inner to outer part of the disc (and vice-versa) driven by an actuator assembly. The heads that access sectors on discs are locked together on the actuator assembly. For this reason, all the heads move in and out together and are always physically located at the same track number (e.g., it is impossible to have one head at track 0 and another at track 500). Because all the heads move together, each of the tracks on all discs is known as a cylinder for reasons that these tracks form a cylinder since they are equal-sized circles stacked one on top of the other in space. So, for example, if a disc drive has four discs, it would normally have eight heads, and a cylinder number 680 would be made up of a set of eight tracks, one per disc surface, at track number 680. Thus, for most purposes, there is not much difference between tracks and cylinders since a cylinder is basically a set of all tracks whereat all the heads are currently located.

Typical disc drives also incorporate a controller. The controller, oftentimes an application specific integrated circuit (ASIC), is the central hub through which information passes in a disc drive. It encompasses an interface to connect the drive to the host computer, for example a SCSI host. It further encompasses a formatter which translates physical disc locations to logical block locations, and retrieves/releases information from/to the disc read/write channel. The controller further encompasses a buffer controlling section for throttling and queuing of data to be written/read to/from the disc.

One of the heads must first be positioned over the correct location of a sector on the disc in order to access (i.e., read or write) the sector. This requires the heads to move to the correct track and then wait for the correct sector to pass under the appropriate head. Moving the heads to the correct track is measured by seek time. A head seek in a disc drive occurs on the order of milliseconds.

Once a seek has finished and while the disc rotates to a correct sector, the servo mechanism continuously interprets servo burst information from the track to ensure the head remains positioned correctly. Essentially, servo bursts, also known as servo wedges, aid in steering the head over the track. The time elapsed while waiting for a correct sector to pass under the appropriate head is measured by latency.

Once the disc has rotated to the correct physical location corresponding to the logical block address (LBA) of the current command, the transfer is started and data is written/read to/from the disc. Under typical operation, commands are often issued to a disc drive faster than the drive can execute them. Accordingly, disc drives employ a queuing mechanism to temporarily store commands for execution at a later time, when the drive finishes execution of already-pending commands. Since commands queued often include write commands, the disc drive must also be able to temporarily store the data sent from the host associated with these commands.

To this end, a write buffer, for example a dynamic random access memory (DRAM), is often utilized. In addition, disc drives often embody a write cache feature, in which a host can send several write commands to a disc drive, and the disc drive will report that the write command has completed once the data for the associated write command has been cached. This feature is particularly useful to coalesce several pending write commands into a single write command to more efficiently write the data to the disc.

As with any data storage and retrieval, data integrity and performance is critical. In the event of a power loss to a typical disc drive, all pending commands and data in the buffer are lost. When power is restored to the drive, any pending commands that had not been completed can not be restored. Disc drives account for this event today by not sending status of commands back to the host until the command has actually completed. However, any write commands in the write cache are considered by the host to have been executed, as the disc drive had already sent command complete status to the host for those commands. The host will therefore consider those lost write commands to be complete, though the disc drive does not contain the correct data. In effect, data in the disc drive becomes corrupt.

Accordingly there is a need for a mechanism which allows a disc drive to preserve the integrity of data in a write cache during the event of a power loss, so that the cached write commands can be executed when power is restored. The mechanism is desirably transparent to the normal operation of the disc drive, and implemented in a relatively simple fashion to minimize associated components and cost.

### SUMMARY OF THE INVENTION

Against this backdrop embodiments of the present invention have been developed. Embodiments of the present invention essentially comprise a system to automatically switch the power supplied to the write cache buffer and minimal circuitry to refresh the write cache buffer to an alternative power source. Power control circuitry to detect a loss of power to the disc drive is employed in the drive. This circuit puts the drive into a low-power standby mode when a loss of main power is detected. Control circuitry to maintain the integrity of the DRAM during low-power mode is also on the disc drive. Rather than powering the entire controller chip, an isolated section, or external control circuitry altogether is used to control the operation and refresh of the write cache DRAM. An alternative power source may be located on the drive itself, or connected via an interface on the drive to an external power source. The write cache buffer also contains a unique format to characterize commands according to whether the command has been executed or not, and overhead data to complete the restoration of the commands when disc drive power is restored. Disc drive firmware also accompanies the hardware to control proper execution of the cached write commands both under normal and power-loss conditions.

There is one preferred embodiment by which this can be achieved in a disc drive that is presently envisioned. However, other means will also become apparent to those skilled in the art upon reading the following description. Essentially, when a disc drive loses power, the system reset will be asserted, and the power control circuitry switches to low-power mode. Power is then supplied from the alternative power source to the write cache DRAM control circuitry, and the write cache DRAM itself. When power is restored to the disc drive, the write commands in the write cache are interpreted to determine if write commands are still pending. The drive then executes any pending cached write commands, sends notice to the host of the power loss and recovery sequence, and continues with normal operation. The disc drive is, in effect, ensuring that all write cached commands are properly executed in the event of a power loss.

These and various other features as well as advantages that characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a simplified block diagram of a disc drive and its connection to the host computer system, and further illustrates the main components of the non-volatile write cache system in accordance with a preferred embodiment of the present invention.

FIG. 3 is a simplified block diagram of a disc drive and its connection to the host computer system, and further illustrates the main components of the non-volatile write cache system in accordance with another embodiment of the present invention.

FIG. 4 is a flowchart illustrating the general concurrent logical procedure of the write cache memory control logic in accordance with a preferred embodiment of the present invention.

FIG. 5 is a flowchart illustrating the general concurrent logical procedure of the power control logic in accordance with a preferred embodiment of the present invention.

FIG. 6 is a flowchart illustrating the general sequential logical procedure of the write cache control firmware in accordance with a preferred embodiment of the present invention.

FIG. 7 is a flowchart illustrating the general sequential logical procedure of the write cache power loss recovery firmware in accordance with a preferred embodiment of the present invention.

FIG. 8 is a flowchart illustrating the general sequential logical procedure of the write cache power loss recovery firmware in accordance with another embodiment of the present invention.

### DETAILED DESCRIPTION

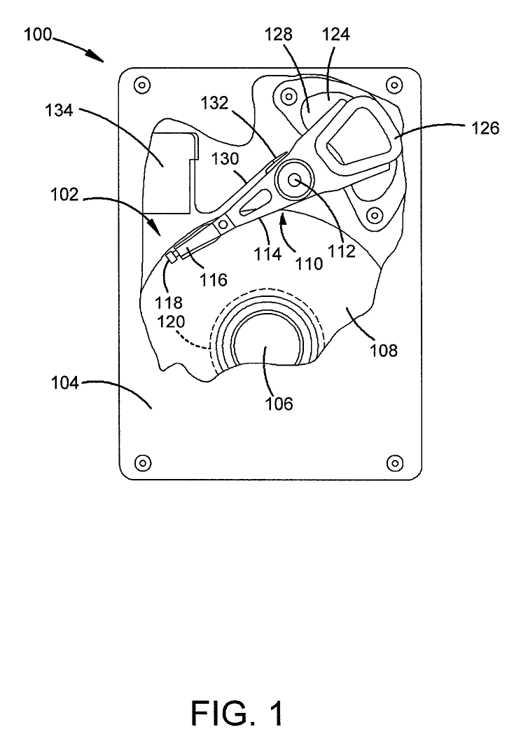

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are typically moved over park zones 120 near the inner diameter of the discs 108 when the spindle motor 106 is de-energized. The heads 118 can be secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly 130 includes a preamplifier 132 to which head wires (not shown) are connected; the head wires being routed along the actuator arms 114 and the flexures 116 to the heads 118. The preamplifier 132 typically includes circuitry for controlling the write currents applied to the heads 118 during a write operation and a preamplifier for amplifying read signals generated by the heads 118 during a read operation. The flex assembly 130 terminates at aflex bracket 134 for communication through the base deck 102 to a disc drive printed circuit board (not shown) mounted to the bottom side of the disc drive 100.

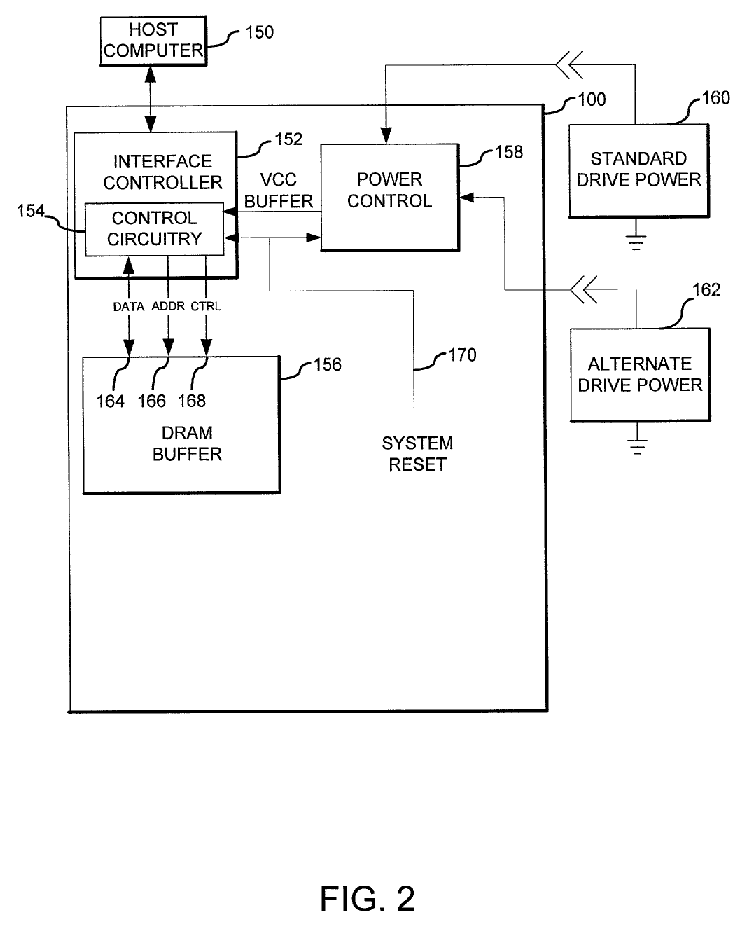

Referring now to FIG. 2, shown therein is a block diagram of the disc drive 100 of FIG. 1, generally showing the vital components of the non-volatile write cache system. The disc drive 100 is shown in FIG. 2 to be operably connected to a host computer 150 in which the disc drive 100 is mounted in a conventional manner. A controller 152 is located on the disc drive 100, and is responsible for data transfer between the host 150 and the discs 108 themselves. Write cache memory control circuitry 154 is located on the controller 152 and is responsible for maintaining the data 164, address 166, and control 168 lines to the DRAM write buffer 156, wherein the write cache memory resides. A power control 158 circuit provides the power source to the control circuitry 154 and the buffer 156 itself. The power control circuit 158 interprets the system reset 170 to determine which power source to use. Connected to the disc drive 110 through the power control 158 circuit is both the standard drive power 160 and the alternate power 162 sources.

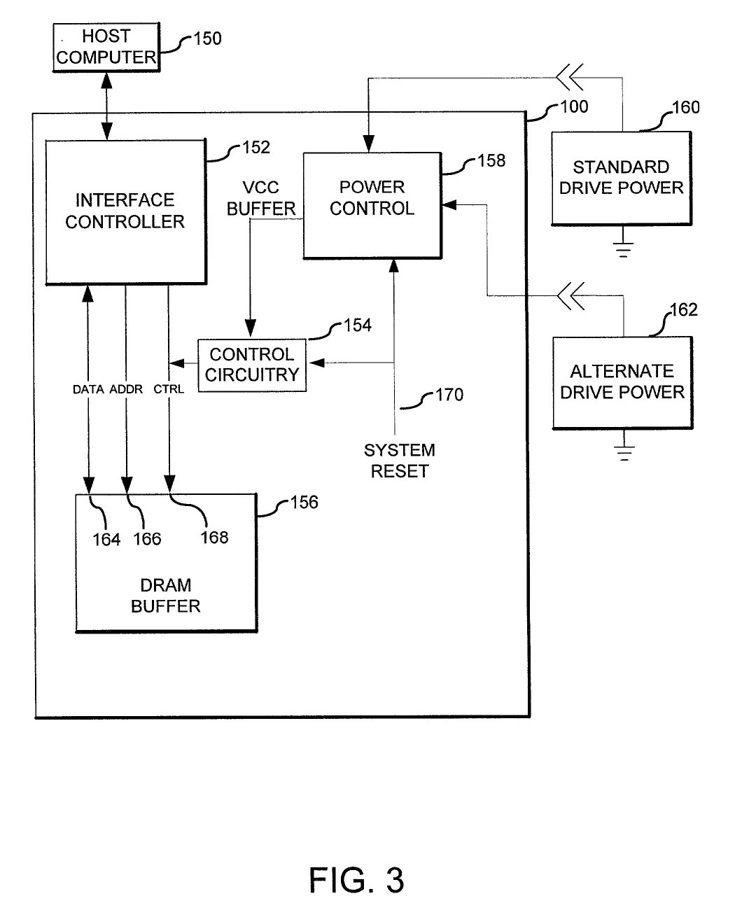

Referring now to FIG. 3, shown therein is a block diagram of the disc drive 100 of FIG. 1, generally showing the vital components of the non-volatile write cache system in another embodiment. The disc drive 100 is shown in FIG. 2 to be operably connected to a host computer 150 in which the disc drive 100 is mounted in a conventional manner. A controller 152 is located on the disc drive 100, and is responsible for data transfer between the host 150 and the discs 108 themselves. Write cache memory control circuitry 154 is located external to the controller 152 and is responsible for maintaining the data 164, address 166, and control 168 lines to the DRAM write buffer 156, wherein the write cache memory resides. A power control 158 circuit provides the power source to the control circuitry 154 and the buffer 156 itself. The power control circuit 158 interprets the system reset 170 to determine which power source to use. Connected to the disc drive 100 through the power control circuit 158 is both the standard drive power 160 and the alternate power 162 sources.

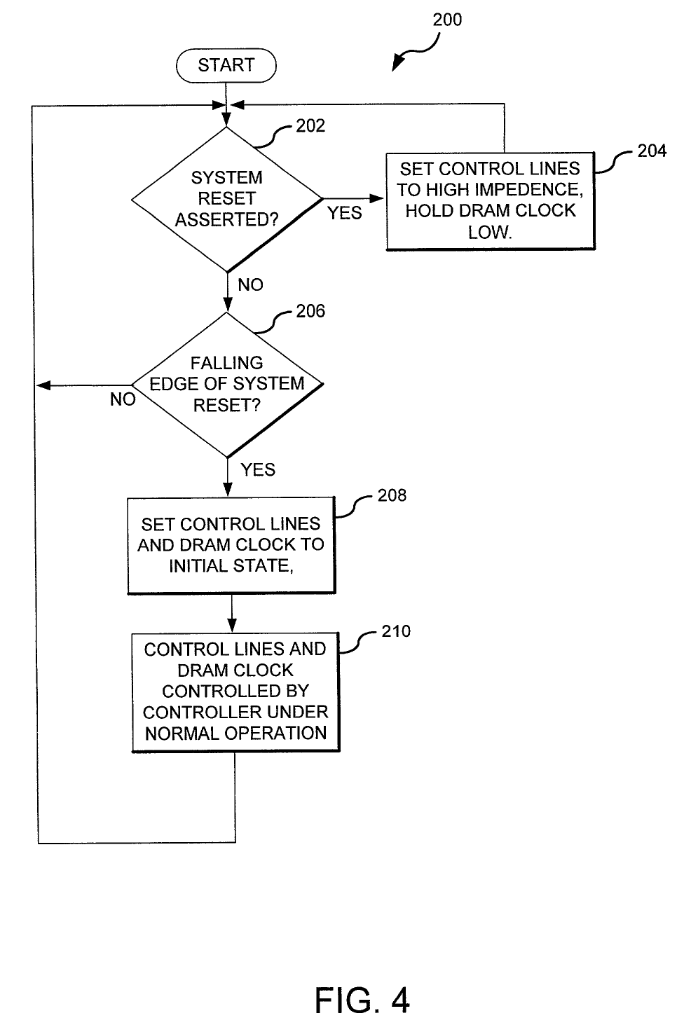

FIG. 4 and FIG. 5 are flowchart descriptions of hardware realized in a preferred embodiment of the present invention.

FIG. 4 is a flowchart illustrating the general concurrent logical procedure of the write cache memory control logic 154 in accordance with a preferred embodiment of the present invention. In query operation 202, system reset 170 is first checked to be asserted. If the disc drive 100 is reset, the control lines 168 are set to high impedance, and the DRAM clock is held low, as indicated in operation 204, and operation continues in operation 202. If the disc drive 100 is not reset, a transition of the reset 170 from reset to not reset is checked for in query operation 206. If a falling edge of the system reset 170 is not encountered, operation continues in operation 202. If a falling edge of the system reset 170 is encountered, operation continues in operation 208, where control lines 168, and the DRAM clock is set to an initial state. After a period of time, the control lines 168, and the DRAM clock are released under the control of the memory control logic 154, in operation 210. Control then transfers back to operation 202.

FIG. 5 is a flowchart illustrating the general concurrent logical procedure of the power control logic 158 in accordance with a preferred embodiment of the present invention. In query operation 252, the system reset 170 is checked to be asserted. If the system reset 170 is asserted, the power control circuit 158 switches the memory 156 power supply to the alternate power source 162 in operation 254. If the system reset 170 is not asserted, the power control circuit 158 switches the memory 156 power supply to the standard power source 160 in operation 256. Control then transfers back to query operation 252.

FIG. 6 is a flowchart illustrating the general sequential logical procedure of the write cache control firmware in accordance with a preferred embodiment of the present invention. The disc drive 100 write cache control firmware begins in query operation 302, where it checks to determine if a write cache command has been received from the host 150. If no write cache command has been received, the firmware simply loops back to query operation 302. If a write cache command has been received, control transfers to operation 304, where the write cache command is placed into the buffer 156. Control then transfers to operation 306, where the priming data in the write cache buffer 156 is initialized. A Boolean commit bit, indicating whether or not the write cache command has been committed, or written, to the media is set to ‘0’. The LBA and blocksize (transfer length) of the write cache command is also stored in the buffer 156. Control then transfers to query operation 308, where the firmware determines if the most recent write command just cached writes to an LBA which a pending write cache command is also to access. If so, control transfers to operation 310, where a counter associated with the LBA is incremented. If the write cache command is determined in query operation 308 to access a unique LBA, control transfers to operation 312. In operation 312, the disc drive 100 returns command complete status to the host 150. Control then transfers back to query operation 302.

Referring still to FIG. 6, concurrently, another process is running to monitor the execution of pending cached write commands. Operation of this process begins in operation 314, where the firmware checks to see if a cached write command has been executed. If no write cached command has been executed, control simply loops back to query operation 314. If a write cached command has been executed, control transfers to operation 316. In operation 316, the commit for the write cached command is set to ‘1’, and the write command cache segment in the buffer 156, is freed to be allocated for new incoming commands. Control then transfers back to query operation 314.

FIG. 7 is a flowchart illustrating the general sequential logical procedure 350 of the write cache power loss recovery firmware in accordance with a preferred embodiment of the present invention. After a power interrupt has been detected, and standard power has been restored, control begins in operation 352, where the LBA counters associated with cached write commands are interpreted to determine the most recent write command associated with each LBA. Control then transfers to operation 354, where the disc drive 100 then executes the pending write commands not yet committed to the media. Control then transfers to operation 356, where the disc drive 100 returns drive ready status to the host computer 150. Control then transfers to operation 358, where the disc drive 100 notifies the host 150 that a power loss occurred, and that it invoked a write cache recovery sequence. Control then transfers back to operation 352.

FIG. 8 is a flowchart illustrating the general sequential logical procedure 400 of the write cache power loss recovery firmware in accordance with another embodiment of the present invention. In this embodiment, after a power interrupt has been detected, and standard power has been restored, control begins in operation 402, where the LBA counters associated with cached write commands are interpreted to determine the most recent write command associated with each LBA. Control then transfers to operation 404, where the pending cached write commands are loaded into the regular disc drive 100 command queue. Control then transfers to operation 406, where the disc drive 100 returns drive ready status to the host computer 150. Control then transfers to operation 408, where the disc drive 100 notifies the host 150 that a power loss occurred, and that it invoked a write cache recovery sequence. Control then transfers back to operation 402.

Essentially, the non-volatile write cache functions is implemented as follows. A disc drive 100 comprises a connection for an alternate power source 162. In one embodiment, the alternate power source 162 is external to the disc drive 100, and may be located in a drive carrier for insertion into large disc drive arrays. In another embodiment, the alternate power source 162 may located on the disc drive 100 itself. The alternate power source 162 may comprise any number of voltage sources, for example a battery, or capacitor. On the disc drive 100, a power control circuit 158 routes either the standard drive power 160, or the alternate drive power 162 to the write cache memory control circuitry 154 and the write cache DRAM buffer 156 itself. The power control circuit 158 selects which power source to route based on the status of the system reset 170. If the disc drive 100 encounters a loss of power, the system is reset and the power control circuit 158 routes the alternate power source 162 to the memory control circuitry 154 and the write cache DRAM buffer 156. If the disc drive 100 is operating under normal conditions, the system is not reset and the power control circuit 158 routes the standard drive power source 160 to the memory control circuitry 154 and the write cache DRAM buffer 156. The memory control circuitry 154 also determines based on the system reset 170 if it is to operate in low-power mode. If so, it simply goes into a low-power refresh mode to maintain the data integrity of the write cache buffer 156. In a preferred embodiment, the memory control circuitry 154 is located in the interface controller ASIC 152. In another embodiment, the memory control circuitry 154 is located elsewhere as an individual component on the disc drive. In preferred embodiments, both the power control circuit 158 and memory control circuit 154 are implemented in silicon as digitally integrated components. For example, the power control circuit 158 may be implemented as a 2-to-1 multiplexer. The memory control circuitry 154, may be implemented with minimal combinational and sequential logic. In other embodiments, the power control circuit 158, and memory control circuit 154 may be implemented in analog devices.

While under normal operation, the disc drive 100 firmware checks for incoming write cache commands. When it encounters such a command, it files it into the write cache buffer 156. Priming data is then initialized in the write cache buffer 156 for each write cache command. A commit bit is set to ‘0’ to indicate the write cache command has not yet been executed, and the LBA and blocksize, or transfer length, are stored for recovery purposes. The firmware also checks to determine if the last write cache command received is to write to an LBA that an already existing write cache command is also to access. If so, a counter associated with the LBA is incremented. The highest counter value associated with each LBA indicates the most recent data to be written to that location. In a preferred embodiment, the counter is 7 bits in length, the LBA is 32 bits, and the blocksize is 16 bits. In a preferred embodiment, the maximum number of outstanding write cache commands is 64. The total overhead associated with the non-volatile write cache primer data is calculated as 64·(1 bit+7 bits+32 bits+16 bits)=3584 bits, or 3.5 KB. Finally, the firmware returns command complete status to the host 150. Although the data has not yet been committed to disc 108, under write caching, the disc drive 100 returns command complete status as soon as the write command has been cached. It is critical to note that the disc drive 100 does not return command complete status to the host 150 until after the write command and priming data have been cached. In the preferred embodiment, if a power loss were to occur while the command was being cached, the disc drive 100 would be unable to return command complete status, and the host computer 150 would recognize that it needed to resend the command. However, if the disc drive 100 were to send command complete status before the command were cached and a power loss occurred during the caching of the command, the command would be unrecoverably lost, and the host computer 150 would be unaware of the resultant data corruption.

Concurrently, the firmware continuously checks to determine if cached write commands are executed. When they are, the commit bit is cleared for the associated command, and the cache segment in the buffer 156 is released.

After a power loss has occurred, and stand drive power 160 has been restored, the firmware enters a write cache recovery sequence. In a preferred embodiment, the firmware first interprets the counters associated with the LBA's of cached write commands, and then executes any uncommitted commands (according to the commit bit). Once all cached write commands have been cleared, the disc drive 100 returns ready status to the host computer 150, and subsequently notifies it that it experienced a power loss and entered a write cache recovery sequence. In another embodiment, rather than execute the pending cached write commands, the disc drive 100 simply transfers the commands into the command queue before returning ready status to the host computer 150. In an embodiment of a SCSI disc drive, this information is preferably returned in the Sense Data, for example in the Additional Sense Code Qualifier. This is also preferably implemented in a Fibre Channel disc drive. In another embodiment, a similar mechanism can be implemented in an ATA disc drive.

In summary, an embodiment of the present invention may be viewed as a nonvolatile write cache, in a disc drive, using an alternate power source for the purpose of maintaining the integrity of data contained in a write cache buffer (such as 156) in the event of a loss of standard drive power (such as 160). The non-volatile write cache in a disc drive (such as 100) with a disc (such as 108) and interface controller (such as 154) utilizes a power control circuit (such as 158) to switch to an alternative drive power source (such as 162), and memory control circuit (such as 154) to enter a low-power mode to maintain a write cache data buffer (such as 156)

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the write authentication test while maintaining substantially the same functionality without departing from the scope and spirit of the present invention. In addition, although the preferred embodiment described herein is directed to a write authentication test for a disc drive system, it will be appreciated by those skilled in the art that the teachings of the present invention can be applied to other systems, like optical storage devices and tape data storage systems, without departing from the scope and spirit of the present invention.

What is claimed is:

1. In a disc drive having a data storage disc, an actuator for positioning a transducer over the data storage disc, a servo controller for positioning of the actuator for accessing data sectors in tracks on the data storage disc, an interface controller for communicating with a host computer, and a memory controller and buffer for caching incoming write commands, a method for maintaining the write commands cached in the memory buffer in the event of a power loss, comprising steps of: p1 (a) detecting a standard drive power loss;
(b) switching from standard drive power to an alternate drive power source;
(c) switching the memory controller into a low-power consumption mode; and
(d) refreshing the write commands in the buffer.

2. The method according to claim 1 further comprising steps of:
(e) detecting a recovery of standard drive power;
(f) switching from the alternate drive power source to the standard drive power;
(g) switching the memory controller into a normal operation mode; and
(h) executing any pending write commands cached in the memory buffer.

3. The method according to claim 2 wherein the write commands cached in the memory buffer further comprise priming data comprising:
a Boolean commit status bit indicating whether a write command has been executed or not;
a Logical Block Address (LBA) of the write command;
a transfer length of the write command; and
a 7-bit counter associated with the LBA of the write command indicating the most recent data associated with the LBA, wherein the 7-bit counter is incremented each time a write command with a duplicate LBA is cached in the memory buffer.

4. The method according to claim 3 wherein the disc drive returns command complete status for a write cached command after the command and priming data have been cached in the memory buffer.

5. The method according to claim 4 wherein the commit bit associated with a write command cached in the memory buffer is set when the write command is executed, and a cache segment in the buffer memory which contained the write command is released.

6. The method according to claim 5 wherein the executing step (h) comprises substeps:
(h) (i) interpreting LBA counters and commit bits associated with write commands cached in the memory buffer;
(h) (ii) executing uncommitted write commands cached in the memory buffer;
(h) (iii) returning drive ready status to the host computer;
(h) (iv) notifying the host computer of a power loss recovery sequence.

7. The method according to claim 5 wherein the executing step (h) comprises substeps:
(h) (i) interpreting LBA counters and commit bits associated with write commands cached in the memory buffer;
(h) (ii) loading uncommitted write commands in the memory buffer into a command queue;
(h) (iii) returning drive ready status to the host computer; and
(h) (iv) notifying the host computer of a power loss recovery sequence.

8. A disc drive having a data storage disc, an actuator for positioning a transducer over the data storage disc, a servo controller for positioning of the actuator for accessing data sectors in tracks on the data storage disc, an interface controller for communicating with a host computer, and a memory controller and buffer for caching incoming write commands, the disc drive comprising:
a non-volatile write cache using an alternate power source to maintain integrity of data stored in the buffer in the event of a standard drive power loss.

9. The disc drive according to claim 8 wherein the non-volatile write cache comprises:
an alternate power source;
a power control circuit to switch power supplied to the memory controller and buffer between standard drive power and an alternate power source.

10. The disc drive according to claim 9 wherein the memory controller and buffer can operate in a low-power consumption mode.

11. The disc drive according to claim 10 wherein the power control circuit and memory controller can switch to the alternate power source according to the status of a system reset of the disc drive.

12. The disc drive according to claim 11 wherein the alternate power source is a battery located on the disc drive.

13. The disc drive according to claim 11 wherein the alternate power source is a battery located external to the disc drive.

14. The disc drive according to claim 11 wherein the alternate power source includes a capacitor located on the disc drive.

15. The disc drive according to claim 11 wherein the alternate power source includes a capacitor located external to the disc drive.

16. The disc drive according to claim 9 wherein the power control circuit is a multiplexer.

17. The disc drive according to claim 8 wherein the memory controller is integrated in the interface controller.

18. The disc drive according to claim 8 wherein the memory controller is external to the interface controller.
